(19) United States
(12) Patent Application Publication
(10) Pub. No.: US 2024/0172050 A1
(43) Pub. Date: May 23, 2024

(54) COOPERATIVE NETWORK DEVICES

(71) Applicant: Silicon Laboratories Inc., Austin, TX (US)

(72) Inventor: Mustafa Murtaza Shamsi, Bharuch (IN)

(21) Appl. No.: 17/989,257

(22) Filed: Nov. 17, 2022

(51) Int. Cl. H04W 28/18

(52) U.S. Cl. CPC H04W 28/18

(57) ABSTRACT

A system and method for optimizing the performance and capabilities of existing wireless networks by enabling cooperative sharing of resources among the network devices in the IoT network. The network devices may share computational resources, sensors or memory capabilities, among other resources. This cooperating sharing is enabled through the use of a framework. The framework enables devices to broadcast the resources that are available for sharing. These resources can be incorporated into a network resource ledger that tracks all of the sharable resources in the network, and the owner of each respective resource. In this way, network devices that are in need of a resource, such as computational power or a sensor, can request that resource from a neighboring network device.

### FIELD

This disclosure describes a system and method for enabling cooperation among network devices.

### BACKGROUND

Recent adoption of IoT (Internet of Things) is exerting pressure on the computational capabilities of network devices, and specifically edge devices. Additionally, recent advances in optimizing machine learning models that allow them to be deployed on the edge computing devices has further increased the pressure on computational and memory capabilities of these devices.

To address this, there are several possible solutions. The first is to increase the computational and memory capabilities of edge devices to handle this increased need. Alternatively, the algorithms executed on the edge devices may be optimized for speed and size. Finally, the edge devices may be configured to be in communication with cloud computing capabilities.

However, all of these approaches focus on either increasing resources at the edge devices or offloading tasks to more capable devices, such as cloud servers.

Both of these approaches have drawbacks. Increasing resources at the edge devices typically means increased power consumption and shortened battery life. Increasing resources at the edge may also imply that the existing hardware needs to be replaced, which may incur additional costs and may not be feasible due to inaccessibility of network devices in IoT. Adding more cloud servers may incur increased cost and complexity. Further, offloading tasks to cloud servers implies a stable and reliable internet connection which may not be available in many scenarios. Also, cloud computing tends to add latency.

Thus, it would be beneficial if there was a system and method for optimizing the performance of a group of edge devices that did not require additional resources or additional cloud servers. Further, it would be advantageous if this system and method could be readily implemented with existing edge devices.

### SUMMARY

A system and method for optimizing the performance and capabilities of existing wireless networks by enabling cooperative sharing of resources among the network devices in the IoT network. The network devices may share computational resources, sensors or memory capabilities, among other resources. This cooperative sharing is enabled through the use of a framework. The framework enables devices to broadcast the resources that are available for sharing. These resources can be incorporated into a network resource ledger that tracks all of the sharable resources in the network, and the owner of each respective resource. In this way, network devices that are in need of a resource, such as computational power or a sensor, can request that resource from a neighboring network device.

According to one embodiment, a method of sharing resources among network devices in a wireless network is disclosed. The method comprises creating a network resource ledger, the network resource ledger listing all resources that are available for sharing and an identity of a device possessing each resource; querying the network resource ledger by a first network device, the first network device in need of a resource; identifying a neighboring network device having the resource; transmitting a packet from the first network device to the neighboring network device requesting access to the resource; and receiving a second packet from the neighboring device granting access to the resource. In some embodiments, the network resource ledger comprises a list of all available resources, a class of resource and their current status. In certain embodiments, the class of resource is one or more of data, compute, connectivity or control. In some embodiments, each resource has a sharing model. In certain embodiments, the sharing model is 1:1, 1:many or 1:many (time sliced access). In some embodiments, the network resource ledger is a two stage table, wherein the first table lists classes of resource and the associated pointer to a second table, and wherein the second table provides a list of devices having a resource of that class. In some embodiments, each network device constructs a device resource ledger, based on resources available in the network device and publicizes its respective device resource ledger, and the network resource ledger is compiled based on all of the device resource ledgers. In some embodiments, the first network device uses the resource and subsequently transmits a packet to the neighboring network device relinquishing access to the resource. In some embodiments, the first network device uses one or more factors to select the neighboring network device, wherein the one or more factors are reliability, highest availability, bandwidth, quality of service, CPU speed, memory storage, or proximity.

In another embodiment, a wireless network is disclosed. The wireless network comprises a plurality of network devices, each network device comprising: network interface; a processing unit; and a memory device, containing instructions, which, when executed by the processing unit, enable the network devices to collectively: create a network resource ledger, the network resource ledger listing all resources in the wireless network that are available for sharing and the network device possessing each resource; and wherein the instructions further enable each network device to: query the network resource ledger for a resource; identify a neighboring network device having the resource; transmit a packet to the neighboring network device requesting access to the resource; and receive a second packet from the neighboring device granting access to the resource. In some embodiments, the network resource ledger comprises a list of all available resources, a class of resource and their current status. In certain embodiments, the class of resource is one or more of data, compute, connectivity or control. In some embodiments, each resource has a sharing model. In certain embodiments, the sharing model is 1:1, 1:many or 1:many (time sliced access). In some embodiments, the network resource ledger is a two stage table, wherein the first table lists classes of resource and the associated pointer to a second table, and wherein the second table provides a list of devices having a resource of that class. In some embodiments, each network device constructs a device resource ledger, based on resources available in the network device and publicizes its respective device resource ledger, and the network resource ledger is compiled based on all of the device resource ledgers. In some embodiments, the network device uses the resource and subsequently transmits a packet to the neighboring network device relinquishing access to the resource. In some embodiments, the network device uses one or more factors to select the neighboring network device, wherein the one or more factors are reliability, highest availability, bandwidth, quality of service, CPU speed, memory storage, or proximity.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a network device;

FIG. 2 illustrates the software framework to enable cooperative sharing among network devices;

FIG. 3A shows the format of a resource descriptor;

FIGS. 3B-3D are several examples of a resource descriptor;

FIG. 4 shows a device resource ledger according to one embodiment;

FIG. 5 shows a network resource ledger according to one embodiment;

FIG. 6 shows a flowchart illustrating the cooperative sharing of a resource; and

FIG. 7 shows the format of a packet requesting access to a shared resource.

### DETAILED DESCRIPTION

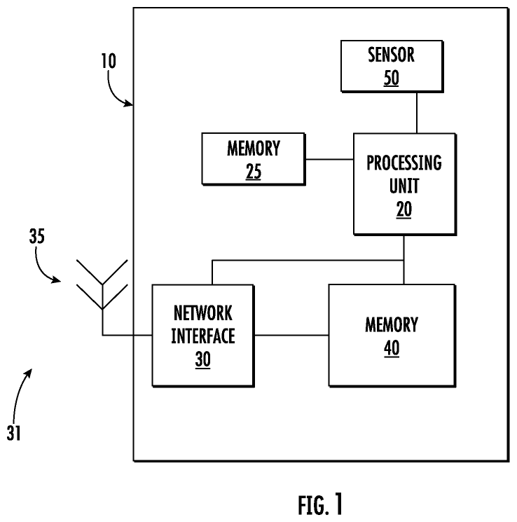

FIG. 1 shows a block diagram of a representative network device 10 that may share resources with other network devices.

The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions, which, when executed by the processing unit 20, enable the network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support Bluetooth, Zigbee or another wireless network protocol.

The network device 10 may include a second memory device 40 in which data that is received and transmitted by the network interface 30 is stored. This second memory device 40 is traditionally a volatile memory. The processing unit 20 has the ability to read and write the second memory device 40 so as to communicate with the other nodes in the wireless network 31.

In some embodiments, the network device 10 may include a sensor 50. The sensor may be a temperature sensor, a light sensor, a microphone, or another type of sensor.

Although not shown, the network device 10 also has a power supply, which may be a battery or a connection to a permanent power source, such as a wall outlet.

While the processing unit 20, the memory device 25, the network interface 30, the sensor 50 and the second memory device 40 are shown in FIG. 1 as separate components, it is understood that some or all of these components may be integrated into a single electronic component. Rather, FIG. 1 is used to illustrate the functionality of the network device 10, not its physical configuration.

The network device 10, and other similar network devices, support a framework that allows the network devices in the wireless network 31 to monitor its own resources, share those resources, along with scanning and utilizing resources of other network devices in the wireless network 31.

The network device that possesses the resource that is being shared may be referred to as the publisher. The network device that shares that resource may be referred to as the subscriber.

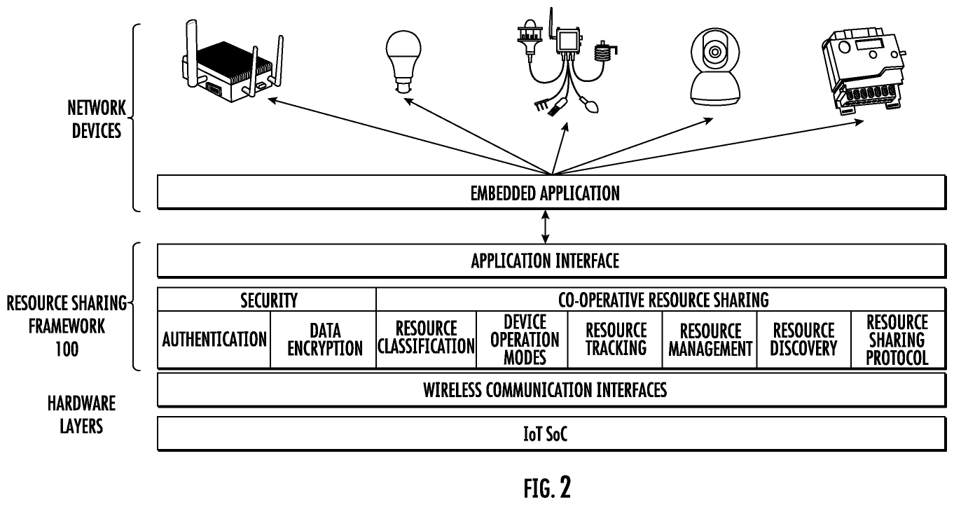

FIG. 2 shows an illustration of this framework. The resource sharing framework is a software centric approach to optimize the performance and throughput of IoT devices. As depicted in FIG. 2, the framework can be implemented on any existing hardware platform.

The resource sharing framework 100 comprises a security component and a cooperative resource sharing component. Each will be described in more detail.

The security component of the framework is responsible for ensuring authenticity, integrity and privacy of the network devices and their associated data. In other words, the security component is responsible for device authentication and data encryption. In scenarios where computational tasks are offloaded onto other nodes, data and instructions could be exchanged across the network opening a possibility of theft of sensitive data. The security component incorporates:
An initial handshake mechanism to verify the identity of the new network device in the wireless network
Data encoding/encryption schemes during transmitting and receiving data between network devices.

The cooperative resource sharing component includes a resource classification module, a device operation mode module, a resource tracking module, a resource management module, a resource discovery module, and a resource sharing protocol module. Of course, in certain embodiments, more or fewer modules may be part of the cooperative resource sharing component.

The resource classification module is responsible for identifying the type of resources that are available in the network device. In some embodiments, the types of resources include computational resources, communications and connectivity capabilities, hardware sensors and actuators, memory and others.

The device operation mode module identifies the operational mode of the network device. In some embodiments, there may be a plurality of modes. In one particular embodiment, there are four modes:
Devices that use the resources of other devices but are not capable of sharing their resources with other devices;
Devices that are not using resources of other devices but have resources that are available for other devices to use;
Devices that use resources of other device and have resources that are available for other devices to use;
Devices that have opted out of the resource sharing framework.

The resource tracking module, the resource management module, and the resource discovery module are responsible for the discovery and tracking of resources in the network. The discovery of resources refers to the scanning of a particular resource in the network. The tracking of resources refers to maintaining a list of discovered resources.

To discover and track resources, a data model defines the various data structures required for implementing a cooperative resource sharing framework for IoT devices. At a high level, the data model includes:
A method to describe every resource that could be shared using this framework;
Data structures to enable resource tracking and management; and
A set of definitions for resource identification, sharing and management.

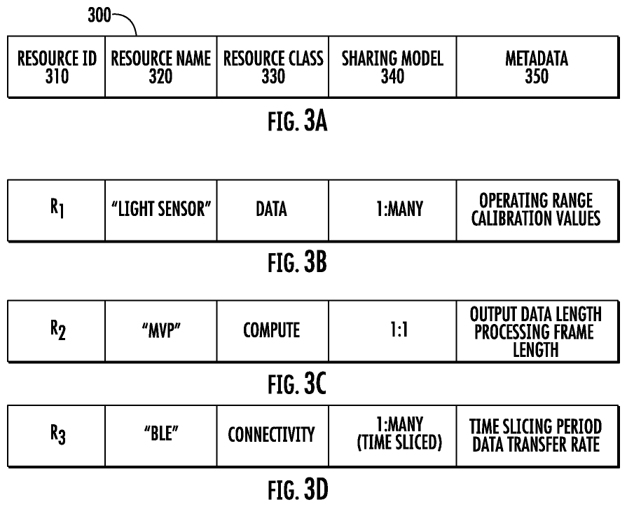

The following is an overview of the data model and its different components. FIG. 3A shows a representative resource descriptor 300.

A resource descriptor is a data structure describing a specific resource. This may be a fundamental data structure of the framework. The structure of the resource descriptor 300 may be influenced by the resource it describes. The resource descriptor is a mechanism by which a device can learn everything about a resource.
Resource ID 310: A unique identifier assigned to a specific resource within a framework. The construct of the identification is implementation defined. An identification of a resource could be universal within a framework, implying that every network device of the wireless network refers to the same ID for a specific resource. Alternatively, the identification may be a combination of the resource type and the device ID, giving a unique ID to the resource for every device. In some embodiments, the resource ID serves as a unique identifier for a specific resource belonging to a specific device.
Resource Name 320: This is a human-readable string describing the resource. In some scenarios, the resource name may also be used to identify a resource in place of its Resource ID.
Resource Class 330: As IoT networks are heterogenous in nature, the resource sharing framework needs to account for various types of resources that could be available in a real-world scenario. Resources are thus grouped into various classes where each class provides some indication on the type of resource. Some of the resource classes may include:
   Data: This class includes all types of data (integer/floating point) generated by sources like sensors, output of an image processing algorithm, and others.
   Compute: This class captures all kinds of computational resources that could be shared within devices. Computational resources include CPU compute, HW accelerators, memory(storage), and others.
   Connectivity: This class captures connectivity resources, including internet connectivity (Wi-Fi/ethernet), connectivity to the local IoT gateway (wired/wireless protocols), and others.
   Control: This class broadly covers resources that can be controlled on a sharing basis. Actuators, such as relays, LEDs, and others fall into this class.
Sharing Model 340: To account for different classes of resources, different sharing models are developed. Some of the possible categories of the resource sharing models are listed below:
   1:1—A resource can be shared with one device at a given point in time. In other words, only one publisher—subscriber connection is allowed at a time. An example of a 1:1 sharing model may be computational resources.
   1: Many—A resource can be shared with multiple devices simultaneously. In other words, one publisher to multiple subscribers is allowed. An example of a 1:Many sharing model may be data resources.
   1: Many (Time Sliced access)—This may be a variation of the 1: Many sharing model where multiple devices can share a single resource in a sequential manner. At a given point in time, a resource is shared with a single network device. As an example, connectivity resources may fit in this category.
Metadata 350: This is an optional field whose contents are resource dependent. Broadly, this field comprises information such as:
   CPU compute time available in case of a compute resource
   Sensor data range/data type/unit for a data resource
   Time period in case a resource is periodically available.

Note that other or different resource classes may be defined.

The purpose of the metadata field is to capture resource specific information which is required at the time of resource sharing and resource tracking. Optionally, a separate data structure may be created, capturing resource specific information that can be indexed into using the resource ID. The metadata table could be used at the time of resource sharing to construct the appropriate packet during resource sharing.

FIGS. 3B-3D shows several examples of a resource descriptor 300. FIG. 3B shows a data class resource, which has a resource ID of R1, a resource name of “Light Sensor” and a sharing model of 1:Many. Unique information associated with a sensor may include operating range, calibration values and others. FIG. 3C shows a compute class resource, which has a resource ID of R2, a resource name of “MVP” and a sharing model of 1:1. Unique information associated with a hardware accelerator may include the output data length, the processing frame length and others. FIG. 3D shows a connectivity class resource, which has a resource ID of R3, a resource name of “BLE”, and a sharing model of 1:Many (time sliced). Unique information associated with the BLE connectivity includes the time slicing period, the data transfer rate and others.

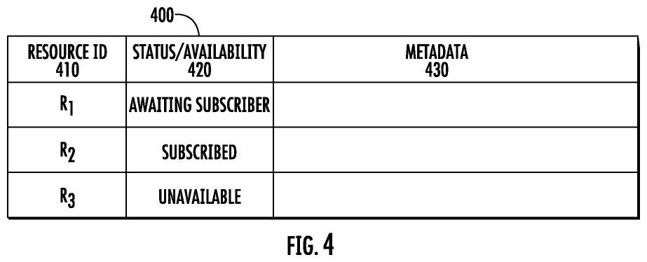

Each network device may also have a device resource ledger, which provides information about the resources and their current status. FIG. 4 shows one possible embodiment of a device resource ledger 400.

In some embodiments, a device resource ledger 400 may include at least some of the following fields:
Resource ID 410: A unique ID of a resource
Status/Availability 420: The status describes whether the resource is available for sharing. Possible values are implementation defined.
MetaData 430: Information describing the resource. This may include characteristics of the resource, the sharing model, or other attributes. If multiple instances of a resource exist, this field may be used to indicate this.

In another embodiment, the device resource ledger 400 may be a concatenation of all of the resource descriptors 300 present in the device.

The definition of the device resource ledger 400 is implementation specific, but the framework uses some type of a device specific ledger for resource sharing and discovery. The device resource ledger 400 is a single source of truth of the available resources for a specific device.

A network resource ledger is a database of all available resources for an entire wireless network. In one embodiment, each network device publicizes its device resource ledger 400, such as by transmitting a packet. These publicized device resource ledgers are then combined to form the network resource ledger. The network resource ledger may be centralized or distributed based on the implementation of the framework and the nature of the wireless network. A network resource ledger is a single source of truth for all the available resources in the wireless network and needs to be updated following specific events.

In the case of a centralized network resource ledger, the ledger may reside on a gateway, a router or a similar device with greater memory and computer capabilities than other devices.

In the case of a distributed network resource ledger, every device may maintain an entire copy of the ledger. Alternatively, each device may retain only a portion of the ledger such that a collection of network devices yields the entire network resource ledger. For example, each network device may retain that portion of the network resource ledger that is of interest to that device. In one illustrative example, a smart LED light may only be interested in other devices which have light sensors that can be shared. A device which is used to determine the spatial position of another device using an Angle of Arrival algorithm may only be interested in other devices that have computational resources that can be shared. In this way, the combination of these partial ledgers from several network devices may represent the network resource ledger.

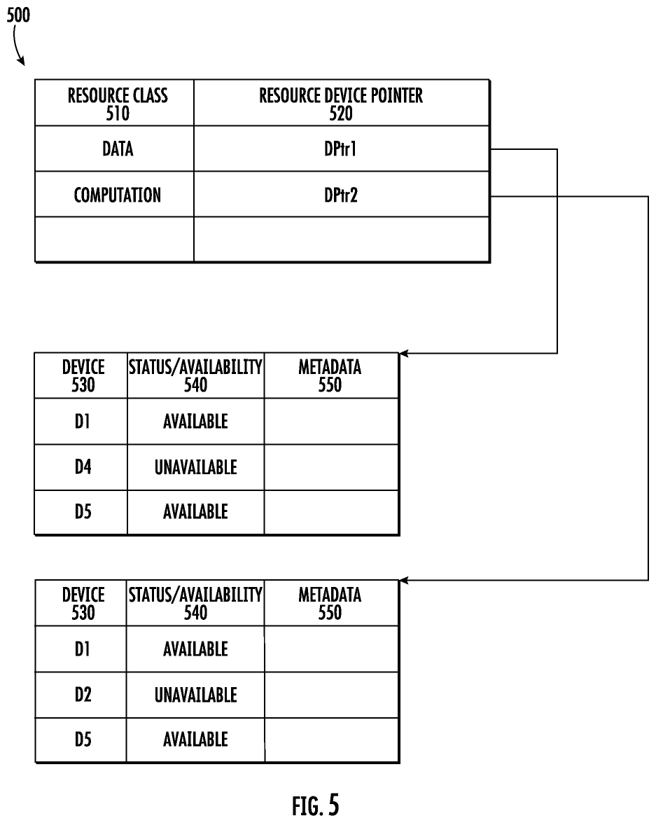

As shown in FIG. 5, the network resource ledger 500 may be arranged as a 2-stage table wherein the first stage table includes a resource class 510 and a pointer 520 to a second table which is the list of devices 530 providing that type of resource in the wireless network. The pointer 520 indexes into a table that lists all of the devices that have the specified resource class. The second table may also include the status/availability 540 of each of the resources. Finally, metadata 550 may also be provided in the second table. As an example, the first stage table may include resource classes such as “compute”, “control”, “data” or “connectivity”. The second stage tables would then list all devices having this resource class. As an example, the second stage table for “connectivity” may list entries for all device IDs that support connectivity, and may include information about the type of connectivity (Bluetooth, Zigbee, WiFi, etc.) provided by that device ID in its metadata.

In another embodiment, the second table may appear as a list of resource descriptors 300, as shown in FIG. 3A.

The network resource ledger 500 may be controlled using an asynchronous state machine. The framework operates based on a set of known commands (or events) that act as triggers for a state transition. The type of resource largely influences the packet structures for resource discovery, sharing and management. The following list is a subset of the possible commands/events supported by the framework:
CMD_ADD_DEVICE—An event to add a new device to the resource sharing network
CMD_REMOVE_DEVICE—An event to remove a device from the resource sharing network
CMD_DEVICE_CLASS_UPDATE—An event to update the operating class of a device in the network
CMD_RESOURCE_STATE_UPDATE—An event to update the availability/status of a resource
CMD_CONTRACT_TERMINATE—An event to terminate the publisher-subscriber contract between 2 devices for a specific resource
CMD_DEVICE_DISCLOSURE—An event where a new device chooses to disclose its resources for the first time. This command triggers an addition of a new device in the network resource ledger
CMD_REQUEST_RESOURCE—An event where a device is requesting a resource from another device in the network
CMD_RESOURCE_START_STREAM—An event to start the resource stream
CMD_RESOURCE_STOP_STREAM—An event to stop the resource stream

The framework also utilizes a plurality of Application Programming Interfaces (APIs) to implement the system and method. Some of these APIs may be associated with framework initialization and configuration. Other APIs may be associated with updating the framework's status. Other APIs may be associated with resource sharing.

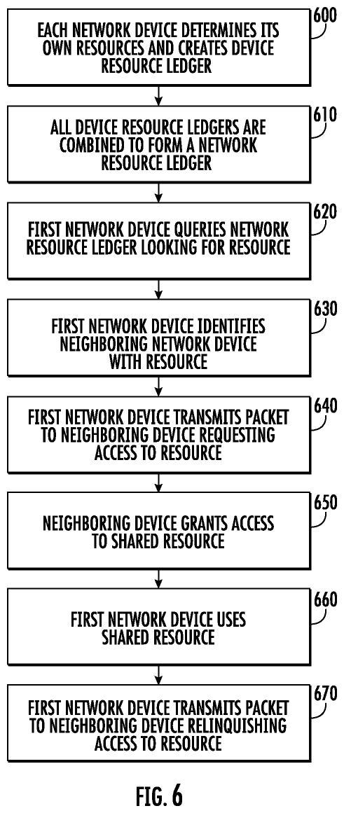

FIG. 6 shows a flowchart showing the operation of the cooperative sharing. First, as shown in Box 600, each network device determines its own resources and creates a device resource ledger. This device resource ledger is then shared, where it is combined with other device resource ledgers to form a network resource ledger, as shown in Box 610. Later, a first network device may require a resource, such as computational power, a sensor, or connectivity. This first network device will then query the network resource ledger, as shown in Box 620. As described above, the network resource ledger contains a list of all available resources in the wireless network and their status. From the network resource ledger, this first network device will identify a neighboring network device that has the resource that is needed, as shown in Box 630.

In a scenario where multiple devices are able to share the same type of resource, the choice of which resource to be used may be based on many factors. These factors may include parameters associated with the resource itself. For example, for connectivity, factors such as quality of service, bandwidth and reliability, may be important for a “connectivity” resource. Factors such as CPU speed and memory storage may be important for a “compute” resource. Factors such as proximity to the first network device may be important for light sensors. Additionally, other factors may be important. One such factor may include the resource with the highest availability or the longest time duration for sharing. Based on the resource class, the first network device may select one or more factors as being important and select the neighboring network device based on these one or more factors. In one particular embodiment, the first network device may apply a weighting factor for each factor and perform a weighted average to determine the best neighboring device to use. Using any of these techniques, the first network device will select the best neighboring device with the desired resource.

The first network device will transmit a packet to the neighboring network device requesting access to that resource, as shown in Box 640.

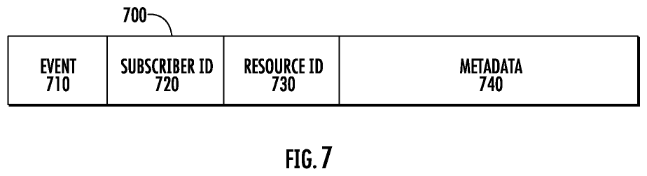

The format of this packet 700 is shown in FIG. 7. Specifically, the packet 700 includes the following:
Event type 710: The type of event that is being performed or reported. Possible event types include, subscribing to a resource, starting to stream that resource, stopping the resource stream, terminating the subscription, and others.
Subscriber ID 720: Informs the neighboring device as to the identity of the first network device.
Resource ID 730: identity of the resource being requested.
Metadata 740: This metadata may include information about sharing, such as the time duration of the subscription or the periodicity of the sharing. The metadata may also include information about the how data is to be exchanged between the first network device and the neighboring device, such as the format of the data and the encryption of that data.

The neighboring network device may then grant the first network device access to that resource, as shown in Box 650. The first network device then uses the resource, as shown in Box 660. This usage maybe short in duration, such as determining the status of a sensor, or may be longer in duration, such as computing an algorithm. When the first network device no longer needs this resource, it may transmit another packet to the neighboring network device, relinquishing access to the shared resource, as shown in Box 670.

The present system and method has many advantages. Having described the framework and the methods by which the network devices in the wireless network cooperatively share resources, several examples will be provided.

In a first scenario, consider a smart street lighting system, with multiple LED lights installed on a street in close proximity to each other. Assume that the ambient light sensing module of a first of the LED lights encounters a fault, rendering the light sensing module non-operational until the hardware fault has been rectified. However, using the above-described framework, an adjacent LED light may share its ambient light sensing module using the techniques described above. Once shared, the first LED light may query the ambient light sensing module of the adjacent LED light, and control its LED based on the output from the adjacent sensing module. This can reduce downtime and allow operation even in the presence of hardware faults.

In a second scenario, consider an automated building infrastructure, where there are multiple smart meters(gas/electric/water) installed at multiple floors to create a network of smart meters which may be used to push meter readings periodically to a central cloud server. Assume that one of more meters loses connectivity with the central cloud server. This could be due to interference, such as may occur with the meters on the lower levels or the basement. Using existing techniques, this event would imply that either the data is lost, or data is stored locally on the node (in this case a smart meter) and push the data to the remote server as soon as remote connectivity is restored.

However, by leveraging the resource sharing framework, these smart meters could seek help from neighboring nodes, which have remote connectivity to the cloud server, to push their data to the remote server. This kind of cooperation among network devices in a wireless network could prevent loss of data and disruption of operation across the network.

Of course, there are many other scenarios where cooperative sharing of resources among network devices in a wireless network may be beneficial.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of sharing resources among network devices in a wireless network, comprising:
creating a network resource ledger, the network resource ledger listing all resources that are available for sharing and an identity of a device possessing each resource;
querying the network resource ledger by a first network device, the first network device in need of a resource;
identifying a neighboring network device having the resource;
transmitting a packet from the first network device to the neighboring network device requesting access to the resource; and
receiving a second packet from the neighboring device granting access to the resource.

2. The method of claim 1, wherein the network resource ledger comprises a list of all available resources, a class of resource and their current status.

3. The method of claim 2, wherein the class of resource is one or more of data, compute, connectivity or control.

4. The method of claim 1, wherein each resource has a sharing model.

5. The method of claim 4, wherein the sharing model is 1:1, 1:many or 1:many (time sliced access).

6. The method of claim 1, wherein the network resource ledger is a two stage table, wherein a first table lists classes of resource and an associated pointer to a second table, and wherein the second table provides a list of devices having a resource of that class.

7. The method of claim 1, wherein each network device constructs a device resource ledger, based on resources available in the network device and publicizes its respective device resource ledger, and the network resource ledger is compiled based on all of the device resource ledgers.

8. The method of claim 1, wherein the first network device uses the resource and subsequently transmits a packet to the neighboring network device relinquishing access to the resource.

9. The method of claim 1, wherein the first network device uses one or more factors to select the neighboring network device, wherein the one or more factors are reliability, highest availability, bandwidth, quality of service, CPU speed, memory storage, or proximity.

10. A wireless network, comprising:
a plurality of network devices, each network device comprising:
network interface;
a processing unit; and
a memory device, containing instructions, which, when executed by the processing unit, enable the plurality of network devices to collectively:
create a network resource ledger, the network resource ledger listing all resources in the wireless network that are available for sharing and the network device possessing each resource;
and wherein the instructions further enable each network device to:
query the network resource ledger for a resource;
identify a neighboring network device having the resource;
transmit a packet to the neighboring network device requesting access to the resource; and
receive a second packet from the neighboring device granting access to the resource.

11. The wireless network of claim 10, wherein the network resource ledger comprises a list of all available resources, a class of resource and their current status.

12. The wireless network of claim 11, wherein the class of resource is one or more of data, compute, connectivity or control.

13. The wireless network of claim 10, wherein each resource has a sharing model.

14. The wireless network of claim 13, wherein the sharing model is 1:1, 1:many or 1:many (time sliced access).

15. The wireless network of claim 10, wherein the network resource ledger is a two stage table, wherein a first table lists classes of resource and an associated pointer to a second table, and wherein the second table provides a list of devices having a resource of that class.

16. The wireless network of claim 10, wherein each network device constructs a device resource ledger, based on resources available in the network device and publicizes its respective device resource ledger, and the network resource ledger is compiled based on all of the device resource ledgers.

17. The wireless network of claim 10, wherein the network device uses the resource and subsequently transmits a packet to the neighboring network device relinquishing access to the resource.

18. The wireless network of claim 10, wherein the network device uses one or more factors to select the neighboring network device, wherein the one or more factors are reliability, highest availability, bandwidth, quality of service, CPU speed, memory storage, or proximity.
